(19) United States
(12) Patent Application Publication
(10) Pub. No.: US 2024/0399869 A1
(43) Pub. Date: Dec. 5, 2024

(54) VIRTUAL REALITY GAME EXPERIENCE IN SELF-DRIVING VEHICLE

(71) Applicant: Telefonaktiebolaget LM Ericsson (publ), Stockholm (SE)

(72) Inventors: Maxim TESLENKO, Sollentuna (SE); Athanasios KARAPANTELAKIS, Solna (SE); Perepu SATHEESH KUMAR, Chennai (IN)

(21) Appl. No.: 18/693,249

(22) PCT Filed: Sep. 22, 2021
(86) PCT No.: PCT/SE2021/050916

§ 371 Date: Mar. 19, 2024

(51) Int. Cl. B60K 35/28; B60N 2/02

(52) U.S. Cl. CPC B60K 35/28; B60N 2/02; B60K 2360/164; B60K 2360/177; B60N 2002/022

(57) ABSTRACT

A method performed by a virtual reality, VR, system for play of a VR game in a self-driving vehicle is provided. The method includes receiving a schedule of predicted acceleration for a future time period for the self-driving vehicle operating in a real world environment. The method further includes, responsive to the schedule of predicted acceleration, adjusting play of the VR game based on the schedule of predicted acceleration. Methods performed by a vehicle system, and related VR systems and vehicle systems are also provided.

### TECHNICAL FIELD

The present disclosure relates generally to virtual reality (VR) game experience in a self-driving vehicle, and related methods and apparatuses.

### BACKGROUND

The automotive industry may be stepping into a new era of self-driving vehicles. Cars may no longer be thought of as just a means of transportation, but also as a new platform for businesses where entertainment may take a central role. Presently, the Society of Automotive Engineers (SAE) defines six levels of driving automation ranging from 0 (fully manual) to 5 (fully autonomous) (referred to herein as “SAE level(s)”). See https://www.sae.org/standards/content/j3016 202104/ (accessed on 7 Sep. 2021). As used herein the term “self-driving vehicle” or “vehicle” refers to an automation level consistent with or equivalent to SAE levels 4 and/or 5. SAE level 4 automation may be within reach for the consumer market. SAE level 4 refers to a level of automation where a vehicle includes a feature(s) that can drive the vehicle under limited conditions and will not operate unless all required conditions are met. Example features include a local driverless taxi, and pedals/steering wheel may or may not be installed. See https://www.sae.org/binaries/content/assets/cm/content/blog/sae-j3016-visual-chart 5.3.21.pdf (accessed on 7 Sep. 2021). SAE level 5 refers to a level of automation where a vehicle includes a feature(s) that can drive the vehicle under all conditions. Example features include, e.g., the same features as SAE level 4, but a feature(s) can drive everywhere in all conditions. Currently, SAE level 5 automation may be more limited by regulation than technology. Remaining hurdles, however, may be eliminated in coming years given social benefits that SAE levels 4 and 5 automation may provide (increased safety, etc.).

As referred to herein, the term “VR” includes both virtual reality and augmented reality (AR).

### SUMMARY

There currently exist certain challenges regarding entertainment in a self-driving vehicle. Rendering a VR scene based on a prediction of acceleration(s) for a self-driving vehicle for a future time period using a time series of a three-dimensional vectors is lacking, including for challenging road conditions. Additionally, road noise and/or vehicle acceleration may pose a threat for a user's experience when misalignment between VR entertainment and a real physical experience causes discomfort or even motion sea sickness due to limitations in scene rendering.

Certain aspects of the disclosure and their embodiments may provide solutions to these or other challenges.

In various embodiments, a method performed by a virtual reality, VR, system for play of a virtual reality, VR, game, in a self-driving vehicle is provided. The method includes receiving a schedule of predicted acceleration for a future time period for the self-driving vehicle operating in a real world environment. The method further includes, responsive to the schedule of predicted acceleration, adjusting play of the VR game based on the schedule of predicted acceleration.

In some embodiments, the method further includes communicating a request to the self-driving vehicle to generate a specified acceleration of the self-driving vehicle. The method further includes receiving a communication from the self-driving vehicle indicating the specified acceleration is scheduled.

In some embodiments, the method further includes executing play of the VR game based on the self-driving vehicle implementing the specified acceleration.

In some embodiments, the method further includes generating the specified acceleration and rotating a seat in the self-driving vehicle, wherein the specified acceleration generates a side acceleration of the user of the VR system located in the rotated seat.

In other embodiments, a method performed by a vehicle system for providing an acceleration requested by a virtual reality, VR, game for play in an self-driving vehicle operating in a real world environment is provided. The method includes performing one of (i) communicating to a processor a schedule of predicted acceleration for a future time period for the self-driving vehicle operating in the real world environment; and (ii) receiving a request to generate a specified acceleration of the self-driving vehicle. The method further includes communicating to the processor an indication that the specified acceleration is scheduled.

In some embodiments, the method further includes assessing whether the requested specified acceleration is within a safe margin to generate in the real world environment. The method further includes, if the requested specified acceleration is within the safe margin to generate in the real world environment, implementing the specified acceleration for the self-driving vehicle in the real world environment.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic illustrating a real-world environment including a self-driving vehicle containing a VR system in accordance with some embodiments of the present disclosure;

FIG. 2 is a schematic illustrating predicted accelerations for a future time period for a self-driving vehicle operating in a real world environment in accordance with some embodiments of the present disclosure;

FIG. 3 is an image of an example rendering of a VR game including a changing roller coaster in a virtual environment;

FIG. 4 is a schematic illustrating movement of a self-driving vehicle to generate game experience acceleration in accordance with some embodiments of the present disclosure;

FIG. 5 is a block diagram illustrating a components of a self-driving vehicle in accordance with some embodiments of the present disclosure;

FIG. 6 is a block diagram illustrating a virtualization environment QQ500 in which functions implemented by some embodiments may be virtualized;

FIGS. 7 and 8 are flow charts illustrating operations of a VR system in accordance with some embodiments of the present disclosure; and

FIGS. 9 and 10 are flow charts illustrating operations of a vehicle system in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Work in entertainment markets in the area of self-driving vehicles has started. See e.g., https://www.forbes.com/sites/solrogers/2018/12/12/the-autonomous-car-is-the-next-entertainment-frontier/?sh=447d045116a9 (accessed on 7 Sep. 2021). For example, in a project referred to as “Concept 26”, passengers may be entertained by watching Netflix content in a driverless car. See e.g., https://www.fortressofsolitude.co.za/self-driving-car-entertainment-with-volvo-ericsson-and-netflix/ (accessed on 7 Sep. 2021).

Certain challenges, however, exist. Video streaming services (e.g., Netflix) and some games take advantage of the fact that users are located in a vehicle and may want to be entertained. Such services and games, however, may not use specifics of the environment inside or outside of the vehicle. To the contrary, road noise and/or vehicle acceleration may pose a threat to a user's experience when misalignment between virtual entertainment and real physical experience causes discomfort or even motion sickness for the user.

While some approaches may use AR to blend entertainment experiences with what is going on around the vehicle, certain challenges exist. For example, in one approach, a vehicle's route towards a destination may be correlated with an AR/VR overlay to present an occupant of the vehicle with an experience (e.g., an AR/VR tour guide). See e.g., U.S. Patent Publication No. 20170236328. In another approach, an infotainment activity may be presented to a vehicle's driver to prepare for a transition from autonomous control of the vehicle to manual control. See e.g., U.S. Patent Publication No. 20170015331. While such approaches may render a VR/AR scene based on routing information or driver-related information, rendering in such approaches is not based on predicted vehicle dynamic and environmental data.

In another approach, an AR world may be created from vehicle data, and the AR world may be adapted based on newly received data from the vehicle. See e.g., U.S. Patent Publication No. 20150097860. While such an approach may target short term vehicle movement prediction based on a reactive time period using current parameters of movement and inputs to a gas, brake pedal etc. and sensors detecting current acceleration, such an approach lacks prediction of vehicle acceleration based on a future time period using a time series of a three-dimensional vectors of predicted accelerations. Additionally, a VR world is not adjusted based on movement of a self-driving vehicle and/or vice versa (that is, where parameters of movement of the self-driving vehicle are adjusted based on a request or need of ta VR world to generate acceleration). Moreover, such an approach lacks generation of a specified acceleration requested by a VR system even in challenging road conditions. Such an approach also lacks synchronization of real-life acceleration of a self-driving vehicle with VR game acceleration without additional hardware because the self-driving vehicle already includes the components used for the acceleration for the future time period.

Various embodiments may provide solutions to these or other challenges.

In various embodiments of the present disclosure, gameplay of a VR game can be adjusted based on movement of a self-driving vehicle and/or vice versa (that is, where parameters of movement of the self-driving vehicle are adjusted based on a request or need of the VR game to generate acceleration).

A prediction of acceleration including a trajectory and vehicle movement for a future time period (e.g., beyond current acceleration, deceleration, and/or turning) for a self-driving vehicle is included. Play of a VR game can be adjusted based on a schedule of predicted acceleration, including based on a request from a VR system for a VR experience.

In various embodiments, gameplay of a VR game is adjusted according to predicted vehicle movement. A trajectory and parameters of movement of a self-driving vehicle are broken down into three types of acceleration: forward acceleration and braking, side acceleration, and vertical acceleration. Based on predicted values for one or more of the three types of acceleration, a VR system adjusts the gameplay to accommodate the acceleration. Parameters of movement refers to types of movement of the self-driving vehicle including acceleration, braking, turning, etc.

Various embodiments may enable VR developers to create applications and games tailored for self-driving vehicles. In some embodiments, a time horizon of prediction of parameters of self-driving vehicle movement is greater than a reactive time perioding use current parameters of movement and sensors detecting current acceleration.

Some embodiments include feedback from a VR game to the self-driving vehicle to adjust parameters of movement of the self-driving vehicle to create a requested game acceleration. In some embodiments, a seat in a self-driving vehicle can be rotated to generate a specified acceleration requested by a VR system. Thus, in such embodiments, play of the VR game may be accomplished even in challenging road conditions (e.g., where the vehicle cannot turn to the side because there is no available road to the side) based on rotation of the seat (e.g., rotating the seat to the side).

Potential advantages provided by various embodiments of the present disclosure may include prediction of acceleration having a further time period than a reactive time period. The schedule of predicted acceleration for the future time period can include a time series of a three-dimensional vectors of predicted accelerations. As a consequence, a scene may be rendered in a VR game on an ongoing basis that synchronizes real life acceleration of a self-driving vehicle with VR game acceleration; and misalignment between virtual entertainment and real physical experience that causes discomfort or even motion sickness for the user may be eliminated or reduced. An additional potential advantage includes that, in some embodiments, a VR system can request a specified acceleration of the self-driving vehicle; and the self-driving vehicle can create the requested acceleration even in challenging road conditions as discussed further herein. A further potential advantage includes that in some embodiments, real life acceleration of a self-driving vehicle can be synchronized with VR game acceleration without additional hardware because the self-driving vehicle already includes the components used for the acceleration.

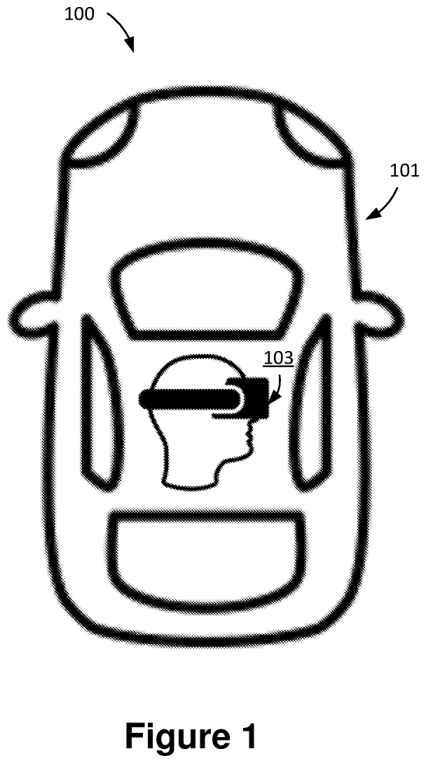

VR gameplay adjustment to movement of a self-driving vehicle is now discussed further. FIG. 1 is a schematic illustrating a real-world environment 100 including a self-driving vehicle 101 containing a VR device 103 in accordance with some embodiments of the present disclosure. In some embodiments, self-driving vehicle 101 can evaluate real-world environment 100 and predict a trajectory and speed for self-driving vehicle 101. The evaluation and prediction may be performed as part of existing self-driving operations without the addition of extra sensor hardware or computational burden on top of what a self-driving vehicle already includes.

In some embodiments, from parameters of movement included in the prediction, an acceleration schedule for a future time period along three axes is predicted. The acceleration schedule includes a time series of three-dimensional vectors of predicted accelerations. The three axes correspond to a forward acceleration direction, a side acceleration direction, and a vertical acceleration direction of the self-driving vehicle 101. Forward acceleration is primarily defined by vehicle 101 acceleration and breaking. Side acceleration is primarily defined by vehicle 101 turning right or left. Vertical 101 acceleration is primarily defined by gravity and by vehicle 101 going over parts of a hill. All three components of the three-dimensional acceleration vectors, however, can be impacted by gravity. In some cases when vehicle 101 and/or a user is positioned flat in space with respect to earth, gravity impacts vertical acceleration; otherwise, in other positions, gravity can also impact side and/or forward acceleration as well.

In some embodiments, a three-dimensional vector of the predicted acceleration is represented as a time series of 3-tuples <aₓ, a_{y}, a_{z},>, where each tuple represents a data sample of a three-dimensional vector of predicted acceleration along three axes. The time horizon of the future time period for the time series depends on how far ahead in time the vehicle 101 is capable of predicting its parameters of movement. The number of data samples for the three tuples depends on the time horizon and/or a sampling frequency of the data. The sampling frequency can be fixed or adjustable to accommodate different road environments. For example, on a highway there can be rather slow changes in acceleration and the sampling rate can be relatively slow compared to quickly changing road conditions in an urban environment (e.g., more turns and more changes in acceleration compared to on a highway).

In some embodiments, the predicted acceleration(s) can be reported to a game application in a VR device 103, and VR device 103 can adjust gameplay to accommodate the predicted acceleration(s).

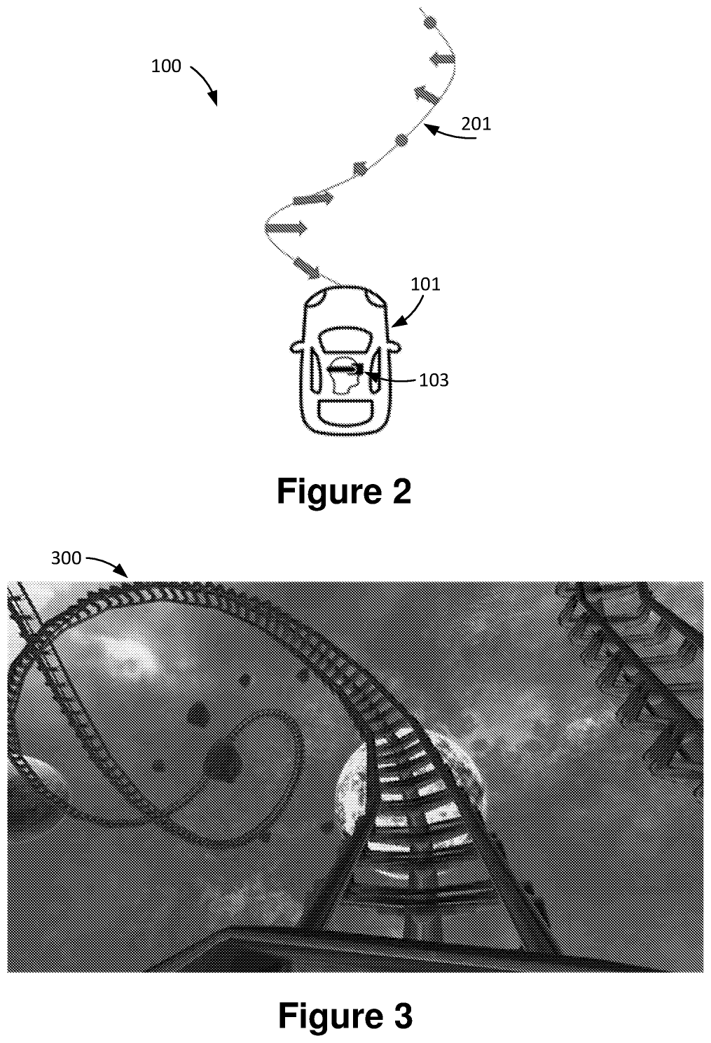

FIG. 2 is a schematic illustrating predicted accelerations 201 for a future time period for self-driving vehicle 101 operating in a real world environment 100 in accordance with some embodiments of the present disclosure. Predicted accelerations 201 include a time series of three-dimensional vectors of predicted accelerations, as illustrated by the arrows along predicted accelerations 201. Each arrow on predicted accelerations 201 corresponds to a three-dimensional vector of predicted acceleration represented as a time series of 3-tuples <aₓ, a_{y}, a_{z},>. Each tuple represents a data sample of the three-dimensional vector of predicted acceleration along three axes.

In some embodiments, an example of a VR game can be a changing roller coaster in a virtual environment. FIG. 3 is an image of an example rendering 300 of a VR game including a changing roller coaster in a virtual environment. See e.g., https://androidappsapk.co/detail-intergalactic-space-virtual-reality-roller-coaster/ (accessed on 9 Sep. 2021). Referring to FIG. 3, in accordance with some embodiments of the present disclosure, the shape of the roller coaster is built for a finite horizon in the virtual world; and the shape of the build is such that expected travel along the roller coaster generates accelerations matching or nearly matching real world 100 accelerations predicted by vehicle 101.

While the VR roller coaster game of FIG. 3 is an example of a VR game that can be played in accordance with various embodiments, the invention is not so limited, and includes any VR game where predicted accelerations of a self-driving vehicle can apply.

Adjustment of self-driving vehicle movement according to VR gameplay will now be discussed further. In some embodiments, a VR game and/or interface of VR device 103 communicates with vehicle 101 the acceleration(s) the VR game requests to create for a user in the game. Vehicle 101 assesses whether such acceleration(s) are safe to generate in real world environment 100 and, if so, schedules and/or communicates towards VR device 103 that the acceleration(s) requested or specified by the VR game are scheduled. Vehicle 101 moves according to the specified/requested acceleration(s). As a consequence, a boring or actionless drive along a highway, for example, may be turned into more dynamic gameplay using, e.g., safe breaking, acceleration, and/or minor turning of the vehicle.

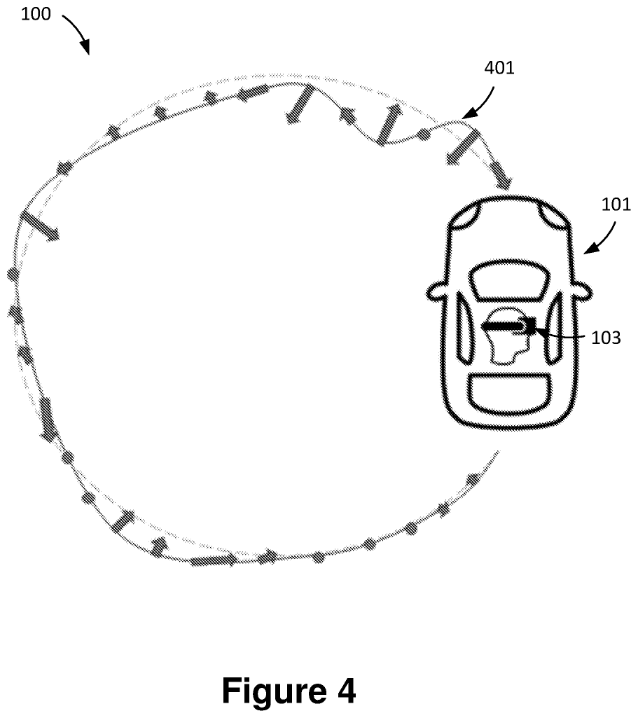

A dedicated gaming experience will now be discussed further. In some embodiments, self-driving vehicle 101 moves to generate game experience acceleration rather then moving passengers to a specific destination. Self driving vehicle 101 is positioned, e.g., in the middle of restricted area within which it can drive, or is moving on a ring having a sloped track, etc. Positioning of vehicle 101 on the ring, for example, can allow maintaining a neutral perception of acceleration while circling at a certain speed in the ring. FIG. 4 is a schematic illustrating movement of a self-driving vehicle 101 to generate game experience acceleration 401 in accordance with some embodiments of the present disclosure. A VR game of VR device 103 reports/requests to vehicle 101 the acceleration to be emulated according to the gameplay. Vehicle 101 executes the specified/requested accelerations. In an example embodiment, the requested/specified acceleration is a sharp acceleration followed by slowly drifting back to a middle position/speed as illustrated by the three-dimensional vectors of trajectory 401.

Example embodiments to transform a three-dimensional vector of vehicle acceleration into a requested or specified VR acceleration are now discussed further. In some embodiments, VR device 103 requests an acceleration(s) and vehicle 101 generates the requested acceleration even in challenging road conditions based on a user of the VR system being positioned on a rotating chair in vehicle 101. In some embodiments, rotation of the chair can be implemented around a vertical axis. In some embodiments, rotation of the chair can be implemented around all axes.

In some embodiments, when vehicle 101 receives a request from VR device 103 to generate an acceleration, vehicle 101 may not be able to execute a move that creates the acceleration in the requested direction due to environment conditions on the road (e.g., due to safety issues, an absence of a road in a particular direction, etc.). By positioning a user in a rotating chair in vehicle 101, however, vehicle 101 can create acceleration in any direction. In response to a request from VR device 103 to generate an acceleration which vehicle 101 cannot execute due to environment conditions, vehicle 101 generates the requested acceleration by rotating the chair such that a three-dimensional vector of acceleration satisfies the requested acceleration. Thus, the seat is rotated such that acceleration generated by vehicle 101 satisfies the requested acceleration with respect to the rotated position of the user of VR device 103.

In an example embodiment, a side acceleration is requested by VR device 103. Vehicle 101, however, cannot make a turn to a side because there is no available road on the side, but vehicle 101 can accelerate or brake because there are no other vehicles in front or back of vehicle 101. Vehicle 101, thus, rotates a chair in which a user of VR device 103 is located such that the user travels sideways. As a consequence, acceleration or braking of vehicle 101 generates side acceleration of the user of VR system 101.

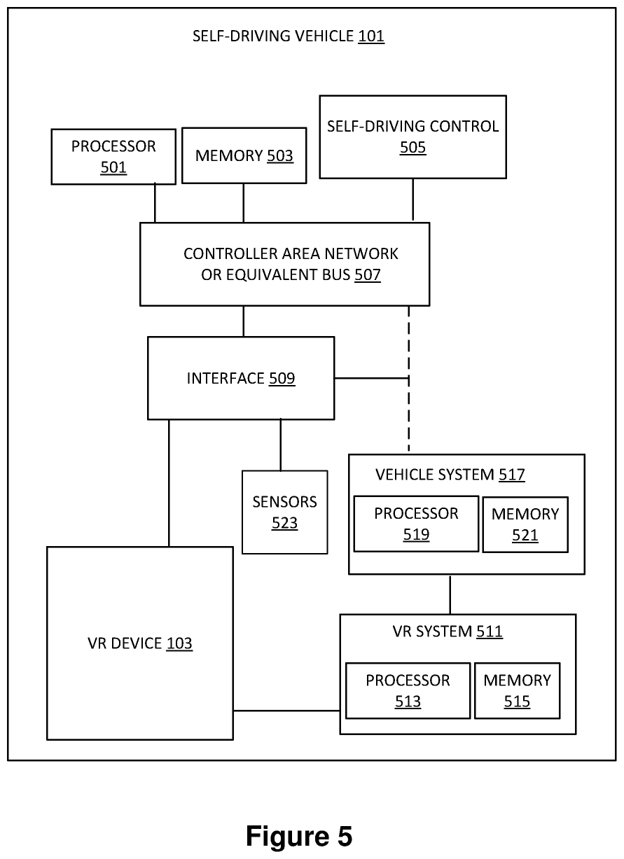

Implementation of components of various embodiments of the present disclosure will now be discussed further. FIG. 5 is a block diagram illustrating a components of a self-driving vehicle in accordance with some embodiments of the present disclosure. Vehicle 101 includes vehicle system 517, which include at least one processor 519 and a memory 521. Vehicle system 517 is integrated with vehicle 101. Vehicle 101 further includes VR system 511 which is part of or integrated with VR device 103. VR system 511 includes at least one processor 513 and memory 515. Vehicle system 517 assesses acceleration of vehicle 101 and reports acceleration(s) and/or responses to requests for acceleration(s) to VR system 511. Vehicle system 517 and/or VR system 511 can be implemented as dedicated hardware unit(s) or as a software package(s) running within vehicle 101 and VR device 103, respectively.

In some embodiments, when vehicle system 517 is implemented as physical hardware, vehicle system 517 can be communicatively connected to a Controller Area Network (CAN) or an equivalent bus of vehicle 101. Through CAN or an equivalent bus, vehicle system 517 can communicate parameters of vehicle 101's movement with a self-driving control module 505 that performs autonomous driving of vehicle 101.

In another embodiment, vehicle system 517 can be implemented as a software module running along with other services in vehicle 101 on at least one processor 501 and/or memory 503 integrated with vehicle 101.

In some embodiments, a VR game can access parameters of sensors 523. Sensors 523 can be communicatively attached to VR hardware (e.g., VR device 103 and VR system 511). In some embodiments, a same type of application interface(s) 509 exposed to the VR hardware can also be exposed to sensors 523.

In some embodiments, when VR system 511 is implemented as physical hardware communicatively attached to VR device 103, VR system 511 can communicate with vehicle system 517 through a dedicated communication channel of any suitable kind. In other embodiments, when VR system 511 is a software module(s) running within VR hardware (e.g., VR device 103 and VR system 511), communication channels available to the VR hardware can be used. For example, many commercially available VR headsets have some form of wireless communication capabilities such as wireless fidelity (WiFi) and/or Bluetooth.

As discussed herein, operations of self-driving vehicle 101 may be performed by processing circuitry 501 and/or interface 509. For example, processing circuitry 501 may control interface 509 to transmit communications through interface 509 to self-driving control 505, vehicle system 517, VR system 511, and/or VR device 103. Moreover, modules may be stored in memory 503, and these modules may provide instructions so that when instructions of a module are executed by processing circuitry 501, processing circuitry 501 performs respective operations (e.g., operations discussed herein with respect to example embodiments relating to self-driving vehicle 101). According to some embodiments, an element(s)/function(s) of self-driving vehicle 101 may be embodied as a virtual node/nodes and/or a virtual machine/machines.

Embodiments of self-driving vehicle 101 may include additional components beyond those shown in FIG. 5 for providing certain aspects of the self-driving vehicle's functionality, including any of the functionality described herein and/or any functionality necessary to support the subject matter described herein. For example, the self-driving vehicle 101 may include user interface equipment to allow input of information into the self-driving vehicle 101 and to allow output of information from the self-driving vehicle 101. This may allow a user to perform diagnostic, maintenance, repair, and other administrative functions, etc. for the self-driving vehicle 101, VR device 103, self-driving control 505, vehicle system 517, and/or VR system 511.

Operations of vehicle system 517 may be performed by processing circuitry 519 and/or interface 509. For example, processing circuitry 519 may control interface 509 to transmit communications through interface 509 to self-driving control 505, VR system 511, and/or VR device 103. Moreover, modules may be stored in memory 521, and these modules may provide instructions so that when instructions of a module are executed by processing circuitry 519, processing circuitry 519 performs respective operations (e.g., operations discussed herein with respect to example embodiments relating to vehicle system 517). According to some embodiments, an element(s)/function(s) of vehicle system 517 may be embodied as a virtual node/nodes and/or a virtual machine/machines.

Embodiments of vehicle system 517 may include additional components beyond those shown in FIG. 5 for providing certain aspects of the vehicle system's functionality, including any of the functionality described herein and/or any functionality necessary to support the subject matter described herein. For example, the vehicle system 517 may include user interface equipment to allow input of information into vehicle system 517 and to allow output of information from the vehicle system 517. This may allow a user to perform diagnostic, maintenance, repair, and other administrative functions, etc. for the vehicle system 517.

Operations of VR system 511 may be performed by processing circuitry 513 and/or interface 509. For example, processing circuitry 513 may control interface 509 to transmit communications through interface 509 to self-driving control 505, vehicle system 517, and/or VR device 103. Moreover, modules may be stored in memory 515, and these modules may provide instructions so that when instructions of a module are executed by processing circuitry 513, processing circuitry 513 performs respective operations (e.g., operations discussed herein with respect to example embodiments relating to VR system 511). According to some embodiments, an element(s)/function(s) of VR system 511 may be embodied as a virtual node/nodes and/or a virtual machine/machines.

Embodiments of VR system 511 may include additional components beyond those shown in FIG. 5 for providing certain aspects of the vehicle system's functionality, including any of the functionality described herein and/or any functionality necessary to support the subject matter described herein. For example, the VR system 511 may include user interface equipment to allow input of information into VR system 511 and to allow output of information from the VR system 511. This may allow a user to perform diagnostic, maintenance, repair, and other administrative functions, etc. for the VR system 511.

Although self-driving vehicle 101 is illustrated in the example block diagram of FIG. 5, the block diagram may represent a self-driving vehicle that includes the illustrated combination of hardware components, other embodiments may comprise a self-driving vehicle with different combinations of components. It is to be understood that a self-driving vehicle comprises any suitable combination of hardware and/or software needed to perform the tasks, features, functions, and methods disclosed herein. Moreover, while the components of a self-driving vehicle are depicted as single boxes located within a larger box, or nested within multiple boxes, in practice, each component may comprise multiple different physical components that make up a single illustrated component (e.g., a memory may comprise multiple separate hard drives as well as multiple RAM modules).

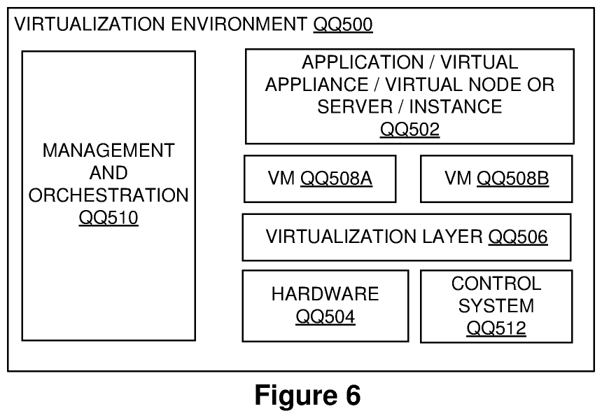

FIG. 6 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any system or device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates in or for a self-driving vehicle. Further, in embodiments in which the virtual node does not require radio connectivity (e.g., a vehicle system or a VR system), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone node with generic or specific components. Hardware QQ504 may implement some functions via virtualization. Alternatively, hardware QQ504 may be part of a larger cluster of hardware (e.g., such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

Although the self-driving vehicles described herein may include the illustrated combination of hardware components, other embodiments may comprise computing devices with different combinations of components. It is to be understood that these self-driving vehicles may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the self-driving vehicle, and/or performing one or more operations based on the obtained information or converted information, and as a result of said processing making a determination. Moreover, while components are depicted as single boxes located within a larger box, or nested within multiple boxes, in practice, self-driving vehicle may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the self-driving vehicle and/or its components as a whole, and/or by users and/or VR devices in a self-driving vehicle generally.

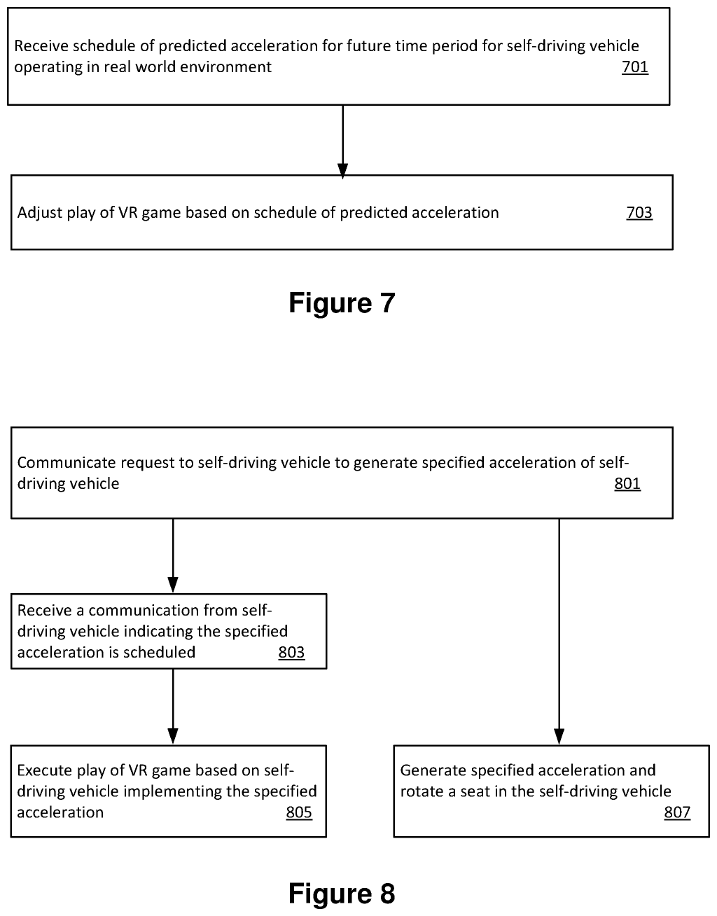

Operations of a VR system (e.g., VR system 511 and/or processor 501) (implemented using the structure of FIG. 5) will now be discussed with reference to the flow charts of FIGS. 7 and 8 according to some embodiments of the present disclosure. In the description that follows, while the VR system may be any of the VR system 511, processor 501, a virtual machine, or a VR system distributed over more than one virtual machine, the VR system 511 shall be used to describe the functionality of the operations of the VR system. For example, modules may be stored in memory 515 of FIG. 5, and these modules may provide instructions so that when the instructions of a module are executed by respective VR system 511 processing circuitry 513, processing circuitry 513 performs respective operations of the flow chart.

Referring to FIG. 7, a method performed by a virtual reality, VR, system for play of a virtual reality, VR, game, in a self-driving vehicle is provided. The method includes receiving (701) a schedule of predicted acceleration for a future time period for the self-driving vehicle operating in a real world environment. The method further includes, responsive to the schedule of predicted acceleration, adjusting (703) play of the VR game based on the schedule of predicted acceleration.

In some embodiments, the schedule of predicted acceleration for the future time period comprises a time series of a three-dimensional vectors of predicted accelerations.

In some embodiments, a three-dimensional vector of predicted acceleration comprises a three tuple representing a data sample of the three-dimensional vector of predicted acceleration along three axes.

In some embodiments, the three axes correspond to a forward acceleration direction, a side acceleration direction, and a vertical acceleration direction of the self-driving vehicle.

In some embodiments, the future time period comprises a period of time corresponding to a prediction of the self-driving vehicle of parameters for movement of the self-driving vehicle operating in the real world environment.

In some embodiments, the number of data samples for the three tuples is based on at least one of a future time period and a frequency of sampling of data.

In some embodiments, the frequency of sampling of data comprises a fixed frequency or an adjustable frequency based on different conditions of the real world environment for operation of the self-driving vehicle.

In some embodiments, the different conditions comprise a type of road environment.

In some embodiments, the adjusting play (703) comprises a generation of an acceleration in a virtual environment of the VR game that corresponds to a predicted acceleration in the schedule of predicted acceleration.

Referring now to FIG. 8, in some embodiments, the method further includes communicating (801) a request to the self-driving vehicle to generate a specified acceleration of the self-driving vehicle. The method further includes receiving (803) a communication from the self-driving vehicle indicating the specified acceleration is scheduled.

In some embodiments, the method further includes executing (805) play of the VR game based on the self-driving vehicle implementing the specified acceleration.

In some embodiments, the self-driving vehicle operating in the real world environment comprises the self-driving vehicle operating in a dedicated gaming environment.

In some embodiments, the method further includes generating the specified acceleration and rotating (807) a seat in the self-driving vehicle, wherein the specified acceleration generates a side acceleration of the user of the VR system located in the rotated seat.

Various operations from the flow chart of FIG. 8 may be optional with respect to some embodiments of a method performed by a VR system. For example, operations of blocks 801-807 of FIG. 8 may be optional.

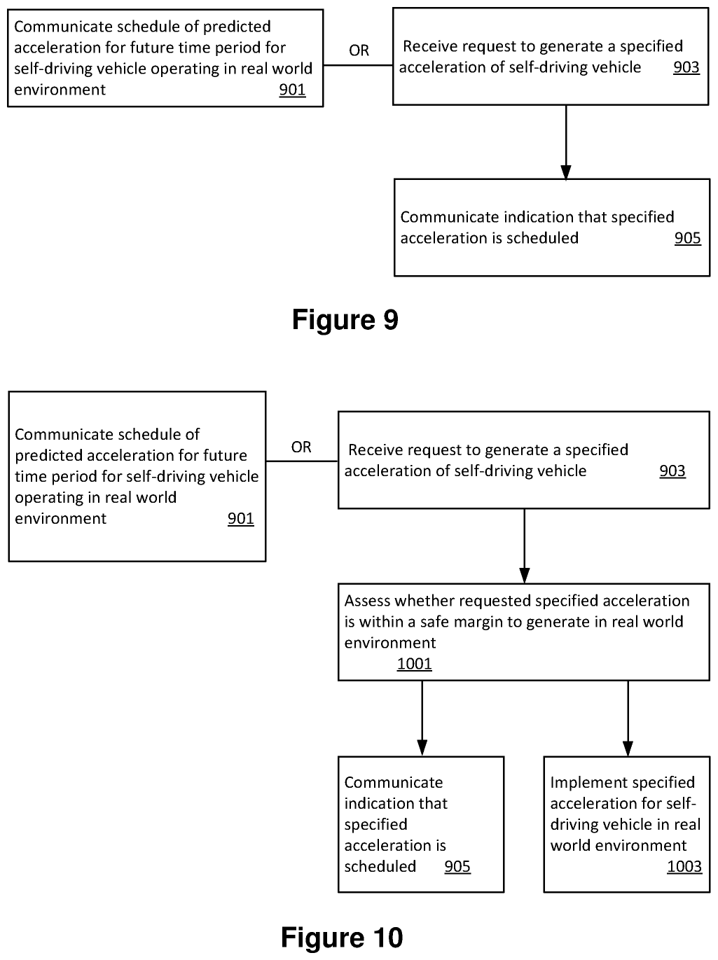

Operations of a vehicle system (e.g., vehicle system 517 and/or processor 501) (implemented using the structure of FIG. 5) will now be discussed with reference to the flow charts of FIGS. 9 and 10 according to some embodiments of the present disclosure. In the description that follows, while the vehicle system may be any of the vehicle system 517, processor 501, a virtual machine, or a vehicle system distributed over more than one virtual machine, the vehicle system 517 shall be used to describe the functionality of the operations of the vehicle system. For example, modules may be stored in memory 521 of FIG. 5, and these modules may provide instructions so that when the instructions of a module are executed by respective vehicle system 517 processing circuitry 519, processing circuitry 519 performs respective operations of the flow chart.

Referring to FIG. 9, a method performed by a vehicle system for providing an acceleration requested by a virtual reality, VR, game for play in an self-driving vehicle operating in a real world environment is provided. The method includes performing one of (i) communicating (901) to a processor a schedule of predicted acceleration for a future time period for the self-driving vehicle operating in the real-world environment; and (ii) receiving (903) a request to generate a specified acceleration of the self-driving vehicle. The method further includes communicating (905) to the processor an indication that the specified acceleration is scheduled.

In some embodiments, the schedule of predicted acceleration for the future time period comprises a time series of a three-dimensional vectors of predicted accelerations.

In some embodiments, the three-dimensional vector of predicted acceleration comprises a three tuple representing a data sample of the three-dimensional vector of predicted acceleration along three axes.

In some embodiments, the three axes correspond to a forward acceleration direction, a side acceleration direction, and a vertical acceleration direction of the self-driving vehicle.

In some embodiments, the future time period comprises a period of time corresponding to a prediction of the self-driving vehicle of parameters for movement of the self-driving vehicle operating in the real world environment.

In some embodiments, the number of data samples for the three tuples is based on at least one of a future time period and a frequency of sampling of data.

In some embodiments, the frequency of sampling comprises a fixed frequency or an adjustable frequency based on different conditions of the real world environment for operation of the self-driving vehicle.

Referring now to FIG. 10, in some embodiments, the method further includes assessing (1001) whether the requested specified acceleration is within a safe margin to generate in the real world environment. The method further includes, if the requested specified acceleration is within the safe margin to generate in the real world environment, implementing (1003) the specified acceleration for the self-driving vehicle in the real world environment.

In some embodiments, the self-driving vehicle operating in the real world environment comprises the self-driving vehicle operating in a dedicated gaming environment.

Various operations from the flow chart of FIG. 10 may be optional with respect to some embodiments of a method performed by a VR system. For example, operations of blocks 1001-1003 of FIG. 10 may be optional.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a virtual reality, VR, system for play of a virtual reality, VR, game, in a self-driving vehicle, the method comprising:
receiving a schedule of predicted acceleration for a future time period for the self-driving vehicle operating in a real world environment; and
responsive to the schedule of predicted acceleration, adjusting play of the VR game based on the schedule of predicted acceleration.

2. The method of claim 1, wherein the schedule of predicted acceleration for the future time period comprises a time series of a three-dimensional vectors of predicted accelerations.

3. The method of claim 2, wherein a three-dimensional vector of predicted acceleration comprises a three tuple representing a data sample of the three-dimensional vector of predicted acceleration along three axes.

4. The method of claim 3, wherein the three axes correspond to a forward acceleration direction, a side acceleration direction, and a vertical acceleration direction of the self-driving vehicle.

5. The method of claim 1, wherein the future time period comprises a period of time corresponding to a prediction of the self-driving vehicle of parameters for movement of the self-driving vehicle operating in the real world environment.

6. The method of claim 3, wherein the number of data samples for the three tuples is based on at least one of a future time period and a frequency of sampling of data.

7. The method of claim 6, wherein the frequency of sampling of data comprises a fixed frequency or an adjustable frequency based on different conditions of the real world environment for operation of the self-driving vehicle.

8. The method of claim 7, wherein the different conditions comprise a type of road environment.

9. The method of claim 1, wherein the adjusting play comprises a generation of an acceleration in a virtual environment of the VR game that corresponds to a predicted acceleration in the schedule of predicted acceleration.

10. The method of claim 1, further comprising:
communicating a request to the self-driving vehicle to generate a specified acceleration of the self-driving vehicle; and
receiving a communication from the self-driving vehicle indicating the specified acceleration is scheduled.

11. The method of claim 10, further comprising:
executing play of the VR game based on the self-driving vehicle implementing the specified acceleration.

12. The method of claim 1, wherein the self-driving vehicle operating in the real world environment comprises the self-driving vehicle operating in a dedicated gaming environment.

13. The method of claim 10, further comprising:
generating the specified acceleration and rotating a seat in the self-driving vehicle, wherein the specified acceleration generates a side acceleration of the user of the VR system located in the rotated seat.

14. A method performed by a vehicle system for providing an acceleration requested by a virtual reality, VR, game for play in an self-driving vehicle operating in a real world environment, the method comprising:
performing one of (i) communicating to a processor a schedule of predicted acceleration for a future time period for the self-driving vehicle operating in the real world environment; and
(ii) receiving a request to generate a specified acceleration of the self-driving vehicle; and
communicating to the processor an indication that the specified acceleration is scheduled.

15. The method of claim 14, wherein the schedule of predicted acceleration for the future time period comprises a time series of a three-dimensional vectors of predicted accelerations.

16. The method of claim 15, where the three-dimensional vector of predicted acceleration comprises a three tuple representing a data sample of the three-dimensional vector of predicted acceleration along three axes.

17. The method of claim 16, wherein the three axes correspond to a forward acceleration direction, a side acceleration direction, and a vertical acceleration direction of the self-driving vehicle.

18. The method of claim 14, wherein the future time period comprises a period of time corresponding to a prediction of the self-driving vehicle of parameters for movement of the self-driving vehicle operating in the real world environment.

19. The method of claim 16, wherein the number of data samples for the three tuples is based on at least one of a future time period and a frequency of sampling of data.

20. The method of claim 16, wherein the frequency of sampling comprises a fixed frequency or an adjustable frequency based on different conditions of the real world environment for operation of the self-driving vehicle.

21-38. (canceled)
